(19) United States
(12) Patent Application Publication
(10) Pub. No.: US 2009/0315753 A1
(43) Pub. Date: Dec. 24, 2009

(54) Apparatus and method for managing memory of a digital video recorder

(75) Inventor: Rong Le, Schenectady, NY (US)

Correspondence Address: FRISHAUF, HOLTZ, GOODMAN & CHICK, PC, 220 Fifth Avenue, 16TH Floor, NEW YORK, NY, 10001-7708, US

(73) Assignee: Contec LLC, Schenectady, NY (US)

(21) Appl. No.: 12/214,508

(22) Filed: Jun. 19, 2008

(51) Int. Cl. G08C 19/12

(52) U.S. Cl. 341/176; 348/734; 348/E05.096; 340/825.69

(57) ABSTRACT

A method for clearing a memory component of an electronic device using a universal remote control unit includes initiating, by a user, an upgrading mode; entering, by a user, a code associated with a device to be controlled by the remote control unit; entering, by a user, a signal formatting data entry which includes signal formatting data, via the keys of the keypad, to be stored in memory of the remote control unit; and associating the type of device to be controlled by the remote control unit with the signal formatting data entry. The signal formatting data is formed to allow a sequence of depression of keys to cause the memory component of the device to be cleared.

### FIELD OF THE INVENTION

The present invention relates generally to remote control units in which encoded signal formatting information is stored therein and accessed to generate control signals for remotely controlling one or more electronic devices, and more particularly to remote control units which can be accessed to manage memory of a digital video recorder (DVR) and similar devices, specifically, clear or erase the memory.

The present invention also relates generally to a method of programming channel keys of a remote control unit to perform functions other than a channel memory, and more particularly to a method of programming channel keys of a remote control unit to manage memory of a DVR and similar devices, specifically, clear or erase the memory.

### BACKGROUND OF THE INVENTION

Remote control units have gained widespread popularity for use in remotely controlling electronic devices such as televisions, cable set-top boxes or converters, videocassette recorders (VCR), digital video disc (DVD) players/recorders, digital video recorders (DVR) and stereos. Typically, each electronic device includes a separate remote control unit provided by the manufacturer, to remotely control the specific device. This causes a user with multiple electronic devices to have numerous remote control units, which is very cumbersome and leads to confusion for the user.

In order to eliminate the need for multiple remote control units, universal remote control units have been developed. A universal remote control unit has a plurality of operating modes for controlling a plurality of electronic devices. Each operating mode enables the user to remotely control a corresponding device. Typically, the universal remote control unit includes a plurality of mode push buttons (e.g., CABLE, TV, VCR, DVR, DVD and AUDIO push buttons) which correspond to the different devices to be controlled. The mode push buttons are used to directly change the operating mode of a corresponding device. In order for the universal remote control unit to operate each of the different devices, the remote control unit must be programmed to send a signal which is recognized only by the selected device, to obtain an appropriate response from the device.

Typically, universal remote control units include a memory which stores a plurality of encoded signal formatting information which correspond to signal structures to which specific manufacturer and model number devices are responsive. The signal formatting information commonly varies based on the device to be controlled. Programming the universal remote control unit involves identifying the signal formatting information which generates a signal to which the device to be controlled is responsive.

With the development of new models of televisions, cable set-top boxes or converters, videocassette recorders, digital video disc players/recorders, digital video recorders and stereos, manufacturers sometimes employ new signals and/or signal formats to remotely control the new electronic devices. The new signals and/or signal formats are typically not known to the universal remote control unit manufacturer prior to the public release of a new electronic device. As a result, the universal remote control devices manufactured before a new model electronic device (for example, a television) is publicly available may not include the signal formatting information necessary to generate the control signals to remotely control the new model electronic device. More specifically, the signal formatting information which is utilized to generate the control signals for remotely controlling some new electronic devices may not be stored in the memory of a universal remote control unit which was manufactured before the particular model of electronic device was made available to consumers. Therefore, in order to remotely control such a new electronic device with a previously purchased universal remote control unit, the memory of the remote control unit must be updated to include the signal formatting information which will generate the control signal to which the new electronic device is responsive.

Methods for updating the memory of universal remote control units to include new signal formatting data have been employed. A first method includes dispatching a technician to the user's home to capture the control signals from the remote control unit provided with the new electronic product and downloading the captured signals to the memory of the universal remote controller via a serial or USB port.

Alternative methods include electronically coupling the universal remote control unit to a user's computer and downloading the appropriate signal formatting information to the memory of the remote control unit from a manufacturer, or inserting an additional memory chip which includes the new signal formatting information into the remote control unit.

A further method for use with universal remote control units that include a signal receiver involves directing generated control signals of the remote control unit of the new electronic device at the receiver of the universal remote control unit to capture and store the control signal of the new electronic device.

The known updating methods are for use with universal remote control units which include a serial port, a USB port, a receiver to capture the new control signals or a slot to receive an additional memory chip. However, if the universal remote control unit does not include these features, the prior art methods do not teach how the universal remote control unit could be updated by a user.

### SUMMARY OF THE INVENTION

Therefore, there is a need for a universal remote control unit whose memory can be updated to include new signal formatting data to generate control signals to remotely control a DVR and similar device whose signal formatting information was not previously stored in the memory of the universal remote control device, and a method for achieving the same.

There is also a need for a universal remote control unit which can manage the memory of a DVR and specifically clear or erase the contents of a memory component therein, and a method for achieving the same.

In accordance with one form of the present invention, a universal remote control unit for remotely controlling a plurality of electronic devices, including one which has a rewritable memory, which can be updated with new signal formatting data includes a memory having a plurality of locations for storing signal formatting entries at respective locations in the memory which are permanently written therein, and a location for storing a signal formatting entry which can be rewritten; a keypad having a plurality of keys for entering, by a user, a first sequence of keypad strokes for actuating an upgrade mode, entering, by a user, a second sequence of keypad strokes indicative of new signal formatting data not previously stored in the memory, and entering, by a user, a third sequence of keypad strokes indicative of a desire to cause the memory of the device to be cleared. The remote control unit also includes a transmitter and a processor which, when an upgrade mode is actuated by the user entering the first sequence of keypad strokes, enables the user to enter the second sequence of keypad strokes indicative of the new signal formatting data not previously stored in the memory, and stores the new signal formatting data in one of the plurality of memory locations for storing signal formatting data not previously stored in the memory. The new signal formatting data causes, among other things, entry of the third sequence of keypad strokes to cause the memory of the electronic device having the rewritable memory to be cleared, when the electronic device having the memory is the device being controlled by the remote control unit.

In accordance with another form of the present invention, a method for upgrading a universal remote control unit which includes a keypad having keys with new signal formatting data includes the steps of initiating, by a user, an upgrading mode; entering, by a user, a code associated with a device type to be controlled by the remote control unit; entering, by a user, a signal formatting data entry which includes signal formatting data, via the keys of the keypad, to be stored in the memory of the remote control unit; and associating the device type to be controlled by the remote control unit with the signal formatting data entry.

The signal formatting data may be formed to allow a sequence of keypad strokes, or depressions of the keys, to cause the memory of the electronic device being controlled by the remote control unit to be cleared (when the device is the selected device being controlled by the remote control unit). This signal formatting data may be formed to require depression of a plurality of different keys in a particular sequence to cause the memory of the electronic device to be cleared. Moreover, a time limit may be imposed on the depression of the sequence of keys to cause the memory of the electronic device to be cleared.

In accordance with yet another form of the present invention, an article of manufacture includes a computer usable medium having computer readable program code means embodied therein for updating a memory of a universal remote control unit which includes a keypad having keys, the computer readable program code means in said article of manufacture including a computer usable medium having computer readable program code means embodied therein for initiating, by a user, an updating mode; a computer usable medium having computer readable program code means embodied therein for entering, by a user, a code associated with a device type to be controlled by the remote control unit; a computer usable medium having computer readable program code means embodied therein for entering, by a user, a signal formatting data entry which includes signal formatting data, via the keys of the keypad, to be stored in the memory of the remote control unit; and a computer usable medium having computer readable program code means embodied therein for associating the device type to be controlled by the remote control unit with the signal formatting data entry. The computer readable program code means also include computer usable medium having computer readable program code means embodied therein for forming the signal formatting data to allow a sequence of depression of keys to cause the rewritable memory of the electronic device to be cleared when the electronic device having the rewritable memory is being controlled by the remote control unit.

The above and other objects, features and advantages of the present invention will become readily apparent from the following detailed description thereof, which is to be read in connection with the accompanying drawings.

### BRIEF DESCRIPTION OF THE DRAWINGS

FIG. 1 is a flow chart showing a process for erasing a memory component of a DVR using a remote control unit in accordance with the invention.

FIG. 2A is a flow chart of a process for perform channel memory programming in accordance with a first embodiment of the invention.

FIG. 2B is a flow chart of a process for perform channel memory programming in accordance with a second embodiment of the invention.

FIG. 2C is a flow chart of a process for perform channel memory programming in accordance with a third embodiment of the invention.

FIG. 3A is a flow chart of the method for updating a remote control unit via a keypad with new signal formatting data.

FIG. 3B is a chart showing the update of the memory of the universal remote control unit at Steps 112, 128, 132 and 134 of FIG. 3A.

FIG. 3C is a flow chart of how the update code which has been stored in the method shown in FIG. 3A is used for signal generation.

FIG. 4A is a flow chart of a process for erasing the memory component of a DVR in accordance with a first embodiment of the invention.

FIG. 4B is a flow chart of a process for erasing the memory component of a DVR in accordance with a second embodiment of the invention.

FIG. 5 is a table showing signal formatting data programmed into the remote control unit in accordance with the invention to enable it to be used to clear or erase a memory component of a DVR.

### DETAILED DESCRIPTION OF PREFERRED EMBODIMENTS

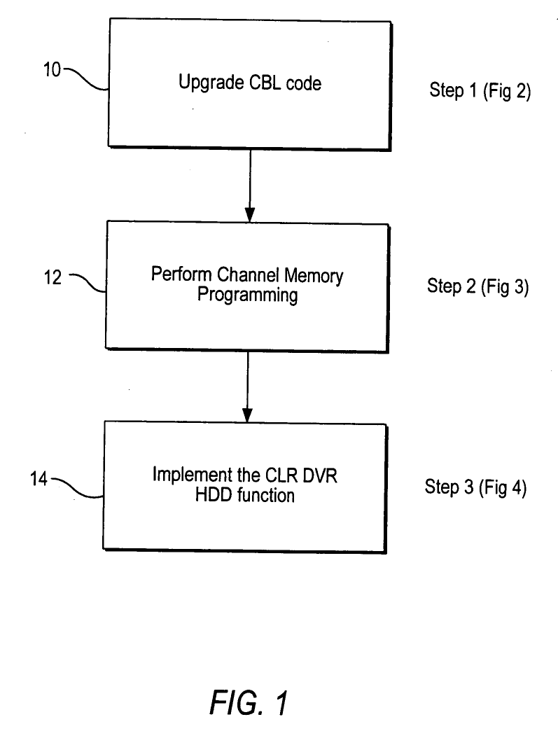

Referring initially to FIG. 1 of the drawings, one process for managing the memory component of a DVR, e.g., erasing the hard drive memory component of the DVR, using a universal remote control unit in accordance with the invention includes a first step of upgrading the cable (CBL) code 10, then performing channel memory programming 12 and then implementing a clear DVR hard drive (HDD) function 14. As used herein the “cable code” is any code which is needed to enable a remote control unit to interact with an electronic device, a cable box being one such electronic device. Since the invention is directed to implementing erasing of a memory component which is usually present in a DVR, digital video recorder, the cable code would therefore be a code which enables the remote control to interact with the DVR.

Upgrading the cable code 10 is typically required since the remote control unit does not have built commands to enable it to be accessed to erase the hard drive of a DVR. Thus, it first needs to be programmed with commands to enable it to erase the hard drive before it can be used to perform this action. Moreover, it is possible that the remote control unit would not have any control commands to enable it to control the consumer's DVR and therefore would also need to be provided with general control commands to enable it to control the DVR, i.e., perform other, traditional functions of the DVR.

Although not shown, the remote control unit includes several keys, including keys designated M1, M2 and M3, which are pressed in a specific order and at specific times to implement the desired functions. Further, the remote control unit may include one or more light-emitting diodes (LED's).

An exemplary universal remote control unit that can be used in the present invention for controlling a plurality of electronic devices is shown in FIG. 1 of U.S. patent application Ser. No. 11/209,279 filed Aug. 22, 2005, the entire disclosure of which is incorporated by reference herein. The universal remote control unit is configured to enter an update mode. The update mode enables a user to input and store new signal formatting data of an electronic device that is non-responsive to the control signals generated by the signal formatting data which are already stored in the memory of the remote control unit, or enables a user to input and store new signal formatting data of a command for an electronic device that is not already stored in the memory of the remote control unit. As described below, this command may be to cause the entire hard drive of a DVR to be erased.

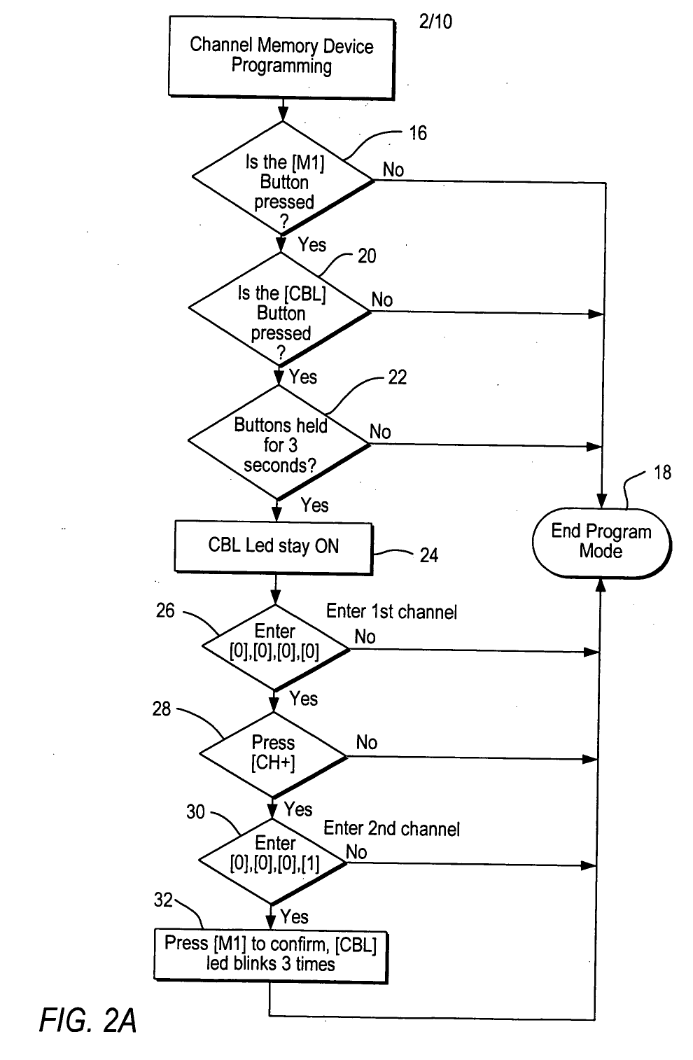

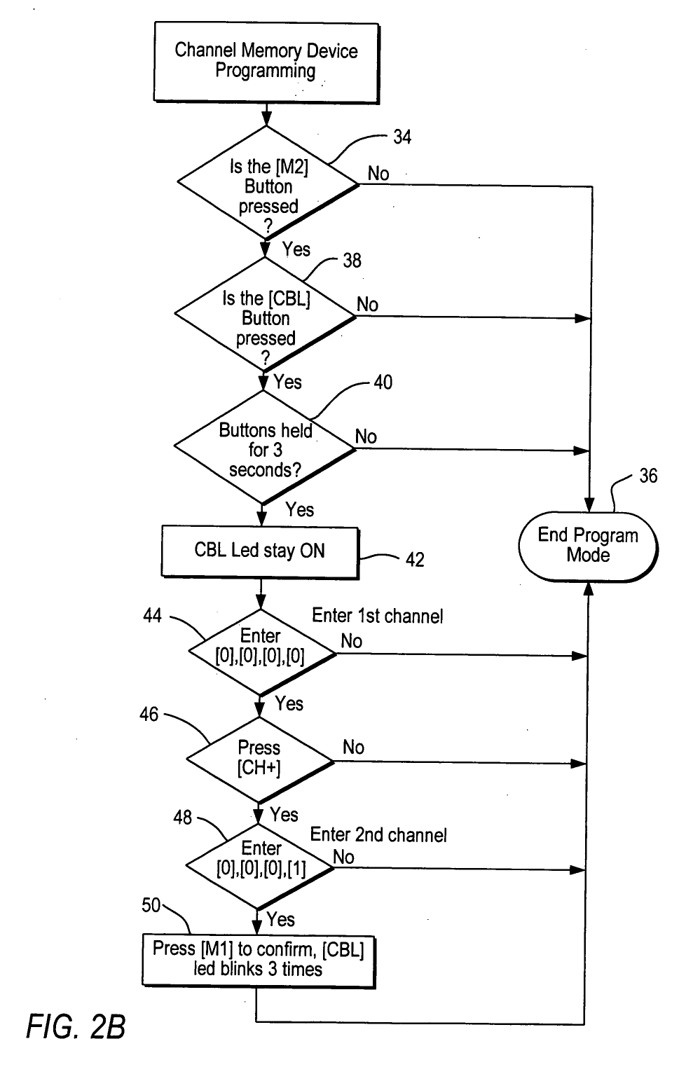

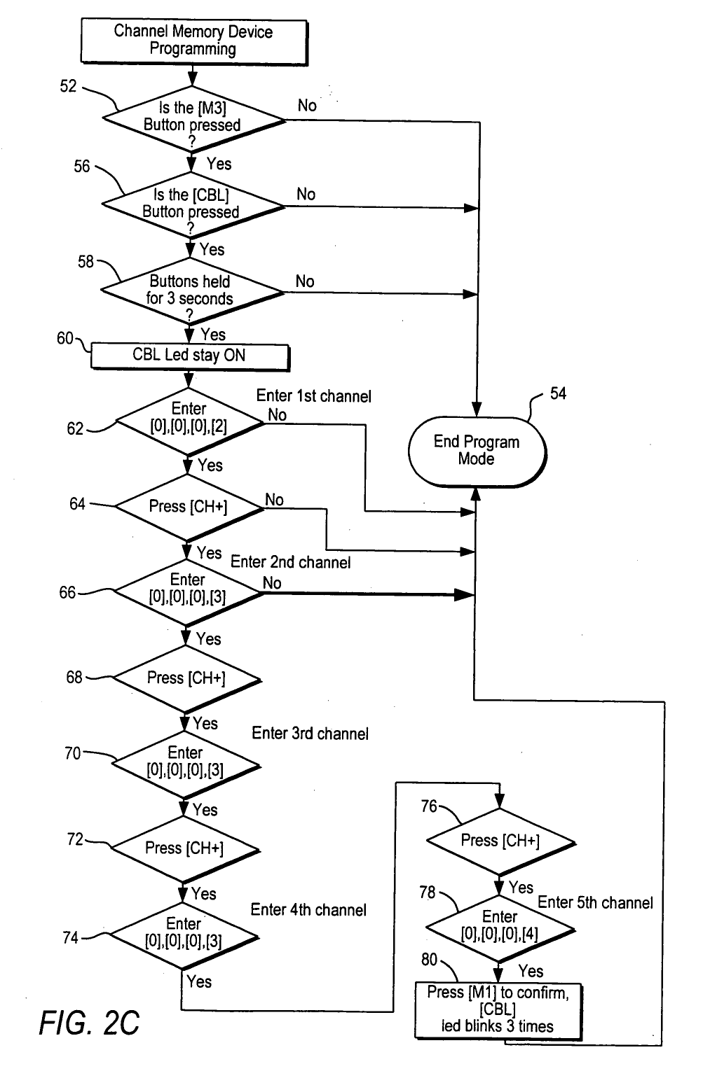

This universal remote control unit includes an input device which preferably includes a keyboard for enabling a user to select a plurality of functions in connection with the operation of the plurality of electronic devices (see FIG. 2 of the '279 application). The keyboard may include a CHANNEL push button, a VOLUME push button, a plurality of numbered (digit) push buttons, and a plurality of video function push buttons. The input device also preferably includes a MODE push button for initiating a mode change for changing the device controlled by the universal control unit, and a plurality of mode push buttons such as a CABLE push button, a TV push button, a VIDEO push button, and an AUDIO push button for placing the universal remote control unit in a respective one of a plurality of operating modes. Desirably, each of the plurality of mode push buttons is illuminable having, for example, a backlit light-emitting diode.

The universal remote control unit further includes a processor, a memory for storing, among other things, a plurality of operating modes, and a transmitter. During operation of the universal remote control unit, activation of one of the plurality of push buttons of the keyboard by a user generates a command signal when depressed. This command signal is supplied to processor. In response thereto and as known in the art, processor retrieves appropriate signal formatting data from memory. The processor then causes the transmitter to generate and transmit signal pulses (a control signal) in accordance with the signal formatting data retrieved from memory, thereby causing one of the controlled devices to carry out the command function.

Preferably, the processor is a programmable infrared (IR) low-voltage micro controller device such as Part No. GMS344XXXT from LG (Goldstar) Semicon Co., Ltd. of Korea. The processor is run by application software or programming (e.g., assembly language) and is typically governed by the manufacturer's protocol. The processor can be a single package design or multiple package design with external or additional memory storage, or any other suitable configuration.

The invention is not limited to such a processing environment, however. The present invention can be incorporated and used within many types of processing environments. From the following description, computer readable program code means for use in processor and for implementing the present invention may be readily programmed by those skilled in the art and stored in memory such as a memory chip or an integrated circuit.

During traditional programming (i.e., set up) of the universal remote control unit, the user identifies the manufacturer of each device to be controlled by the remote control unit, and locates the numerical number assigned to that device from a manufacturer and device type list in the universal remote control unit user manual. Thereafter, through a series of button presses the user will enter a programming mode of the remote control unit. The user then inputs the corresponding numbers assigned to the name of the manufacturer and device type (for example, the three digit number 100 for a Sony TV) from the user manual. Once the number has been successfully entered, a confirmation LED blink will follow to indicate successful programming of the universal remote controller. If it is determined that the numerical code entered by the user is a valid code and operates the device to be controlled, the corresponding ROM address is stored in the RAM (random access memory) portion of the memory. If the first numerical code entered by the user is not a valid code or does not operate the device to be controlled, the user enters another numerical code from the manufacturer and device type list. This process is repeated until a code is identified which operates the device to be controlled.

If, however, the user cannot identify a code from the user manual which operates an electronic device, and the user is desirous of using the remote control unit to control the electronic device, the remote control unit must be updated to include corresponding signal formatting data in the remote control unit's memory to generate an appropriate control signal.

Moreover, if the user wants to perform a new function of the electronic device, e.g., erase the hard drive of a DVR, and is desirous of using the universal remote control unit to perform it, the remote control unit must be updated to include corresponding signal formatting data in the remote control unit's memory to generate an appropriate control signal to enable performance of the new function.

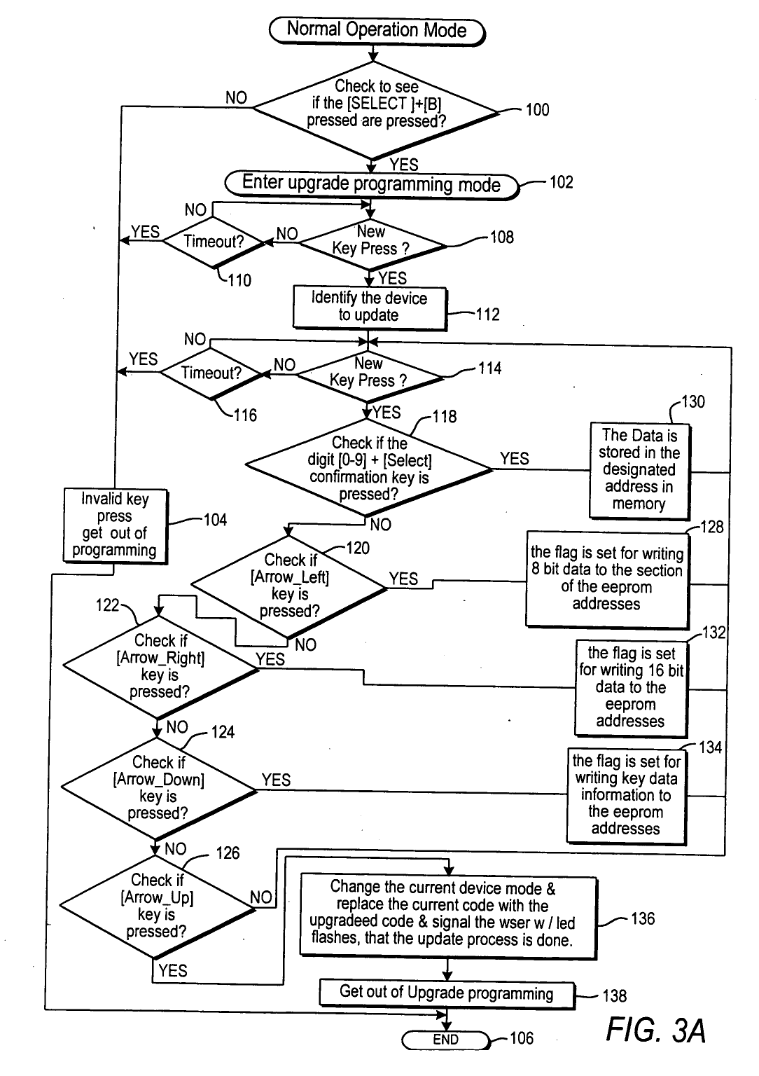

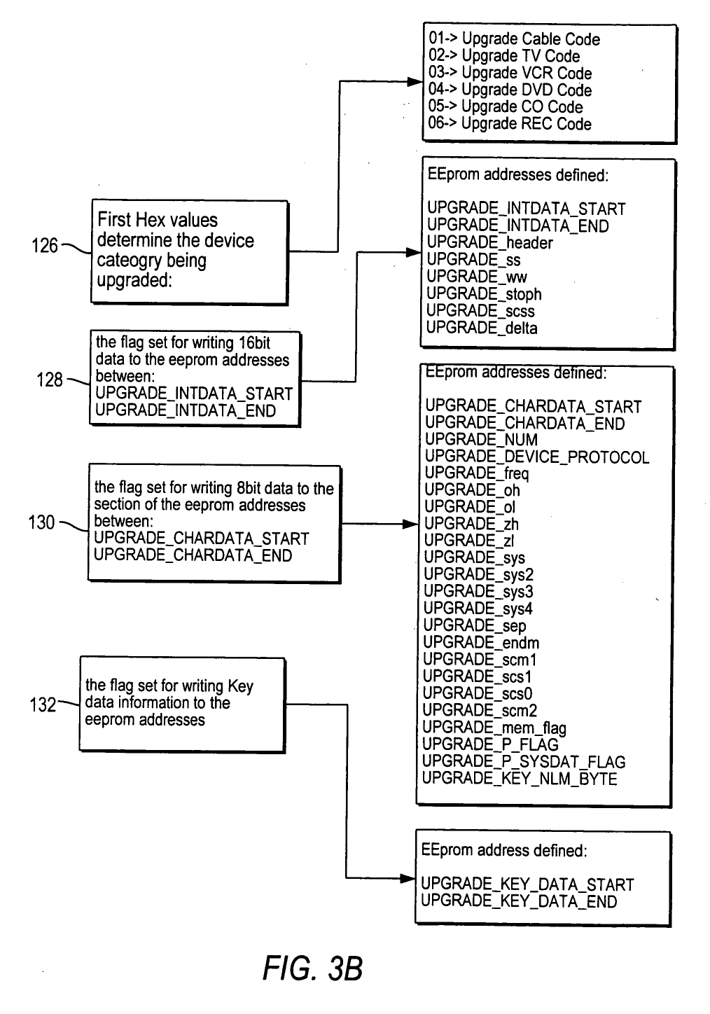

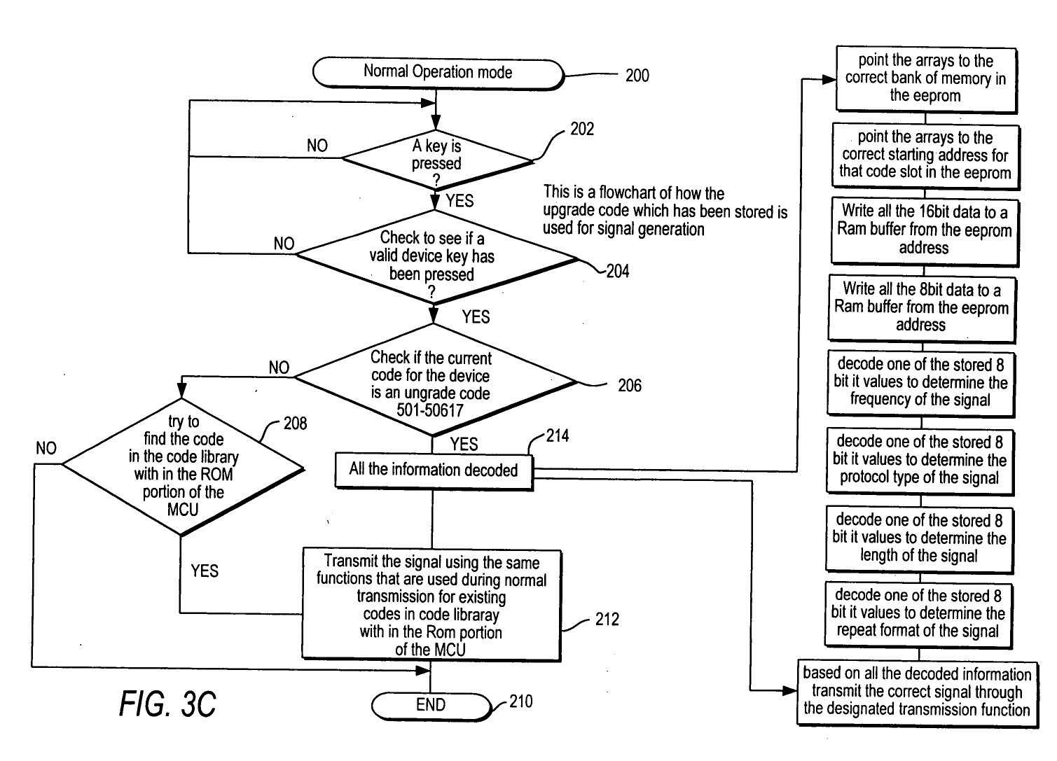

Upgrading of the cable code 10 may therefore be required to enable the user to both access and control the DVR to perform traditional functions thereof and provide a command to erase the memory thereof. FIGS. 3A-3C show different processes for upgrading the cable code 10. The particular stored commands may be selected and formed as desired to enable the upgrading to allow the remote control unit to perform various functions, including, for example, to erase or clear a memory component of the DVR.

FIG. 3A shows a method of updating the universal remote control unit (update mode) to store new signal formatting data.

In order to enter the update programming mode, the remote control unit continuously monitors the keyboard input to determine whether a specific key press sequence occurs (Step 100). In a preferred embodiment, the update mode is entered by pressing the SELECT key and then the B key. If the correct sequence of keys is pressed (SELECT key and then B key) (YES in Step 100), then the universal remote control device enters the update programming mode (Step 102). However, if the sequence of key presses does not correspond to entering the update programming mode (that is, the SELECT key and B key are not pressed) (NO in Step 100), then a determination is made that an invalid key press has been made (Step 104), the upgrade programming mode is not entered, and the remote control unit returns to normal operation (Step 106).

If the update programming mode is entered (YES in Step 102) due to a correct sequence of key presses, a determination is made in Step 108 as to whether subsequent key presses are valid key presses and that the key presses occur within a specific period of time (Step 110) upon entering the upgrade programming mode (for example, within 10 seconds). Specifically, the method is looking for an identification as to the type of device whose signal formatting data is to be updated. In a preferred embodiment, a determination is made as to whether a valid key entry (digit key 0-9) is made (Step 108). If a valid key entry has not been made (NO in Step 108), a determination is made as to whether the predetermined time period has elapsed since entering the programming mode. If the predetermined time period has elapsed since entering the programming mode (YES in Step 110), then it is determined that a valid key press has not been made (Step 104), the upgrade programming mode is exited, and the remote control unit returns to normal operation (Step 106).

If it is determined in Step 110 that the predetermined time period has not elapsed since entering the programming mode (NO in Step 110), then the method returns to Step 108 and monitors for a new key press entry.

If a valid key entry (digit key) is made (YES in Step 108), the key presses entered in Step 108 are analyzed to identify which electronic device will have updated signal formatting data associated therewith (Step 112). In one embodiment, if it is determined in Step 112 that the user depressed the “0” and “1” keys, this is indicative of adding new signal formatting data to the memory to control the cable set-top box. Likewise, if it is determined in Step 112 that the “0” and “2” keys or “0” and “3” keys have been depressed, this is indicative of adding new signal formatting data to the memory to generate a new control code for a television. If it is determined in Step 112 that the “0” and “4” keys have been depressed, the VCR signal formatting data in the memory will be updated. If it is determined in Step 112 that the “0” and “5” keys or “0” and “6” keys have been depressed, this is indicative of updating the signal formatting data in the memory for the DVD player. If it is determined in Step 112 that the “0” and “7” keys have been depressed, this is indicative of updating the signal formatting data in the memory for the CD player, and if it is determined in Step 112 that the “0” and “8” keys have been depressed, this is indicative of updating the signal formatting data in the memory for the audio receiver. If it is determined in Step 112 that the “0” and “9” keys have been depressed, this is indicative of updating the signal formatting data in the memory for the DVR. Although not required, in a preferred embodiment, the user will press the SELECT key after the two digit designation of the electronic device whose signal formatting data is to be updated to provide an indication to the device that the user has completed the digit key entry.

After a determination is made in Step 112 as to which electronic device will have updated signal formatting data associated therewith (that is, “0,” “1” and SELECT for a cable set top box; “0,” “2” and SELECT, or “0,” “3” and SELECT for a television; “0,” “4” and SELECT for a VCR; “0,” “5” and SELECT or “10,” “6” and SELECT for a DVD player; “0,” “7” and SELECT for a CD player; “0,” “8” and SELECT for an audio receiver; or “0,” “9” and SELECT for a DVR), the method monitors the keypad for a new key press (Step 114). That is, the method is now ready to update the memory location corresponding to the signal formatting data of the electronic device designated by the user. The memory stores the subsequent keyed in entries as signal formatting data for the selected device.

Returning now to Step 114, the method monitors the keypad for a new valid key press. A valid key press corresponds to any of the digit keys (0-9), the Arrow Left key, and Arrow Right key, the Arrow Down key, and the Arrow Up key. If a new valid key press is not made (NO in Step 114), then a determination is made in Step 116 as to whether a predetermined period of time has elapsed (for example, 10 seconds) since the last key press. If a valid new key press has not occurred within the predetermined period of time (YES in Step 116), then a determination is made that a valid key press has not been made and the upgrade programming mode is exited (Step 104) and the method returns to normal operation (Step 106). If the predetermined period of time has not elapsed (NO in Step 116), then the method returns to Step 114 to monitor for new key presses.

When a valid new key press is determined in Step 114, that is, either a digit key (0-9), Arrow Left, Arrow Right, Arrow Down, or Arrow Up key is pressed, a determination is made in Steps 118, 120, 122, 124 and 126 as to which valid key press has been made.

In order to update the signal formatting data for a specific electronic device, the user must execute a particular sequence of key presses using the digit keys which is preferably provided by the manufacturer of the remote control unit. It is foreseen that the manufacturer of the electronic device or a third party could also provide this information to the user, as long as the information is specific to the remote control unit and the electronic device. In a preferred embodiment, three groups of signal formatting data information are entered via the keypad to the remote control unit. A first group corresponds to the signal protocol of the control signal to which the specific electronic device is responsive. A second group corresponds to key data information, for example, the type of signal which should be transmitted to the electronic device for each key on the remote control unit. A third group corresponds to additional protocol information, for example, whether to transmit the signal twice to the electronic device, etc. While three groups of signal formatting data are described, it is foreseen that more or less groups could be employed.

In a preferred embodiment, the Arrow Left key, Arrow Right key and Arrow Down key are indicative of portions of the signal formatting data where the newly input key press information should be stored. In a preferred embodiment, the Arrow Left key sets the flag for writing 8 data to the section of the memory corresponding to the first group of signal formatting data, the Arrow Right key sets the flag for writing 16 bit data to the section of the memory corresponding to the second group of signal formatting data, and the Arrow Down key sets the flag for writing key data information to the section of the memory corresponding to the third group of signal formatting data.

Returning now to Step 114, once a valid key press is determined, Steps 118, 120, 122, 124 and 126 monitor for depression of a digit key or arrow key. In a preferred embodiment, the user will first enter an Arrow Left key (Step 120) to set the flag in the memory for writing the first group of signal formatting data (8 bit data) to the corresponding section of the memory (Step 128). The method then returns to Step 114 wherein the sequence of key presses provided by the manufacturer of the remote control unit or the manufacturer of the electronic device are input by the user. In a preferred embodiment, after every two key presses the SELECT key is depressed to indicate that the just entered data is to be stored in the memory of the remote control unit. In this way, if the user depresses an incorrect key and the SELECT key has not been actuated, the user can re-enter the correct sequence of key entries which will overwrite or erase the prior (incorrect) key entries.

Once the user has depressed the correct sequence of digit keys and the SELECT key is depressed (YES in Step 118), the data is stored in the area of memory designated in Step 128 (Step 130). The method then returns to Step 114 to identify new valid key presses by the user. Once all of the 8 bit data corresponding to the first set of signal formatting data information is entered by the user and stored in the designated section of memory (Steps 114, 118, 130), the user then presses the Arrow Right key. If it is determined that the Arrow Right key is pressed (YES in Step 122), the flag is set in the memory for writing the second group of signal formatting data (16 bit data) to the corresponding section of memory (Step 132).

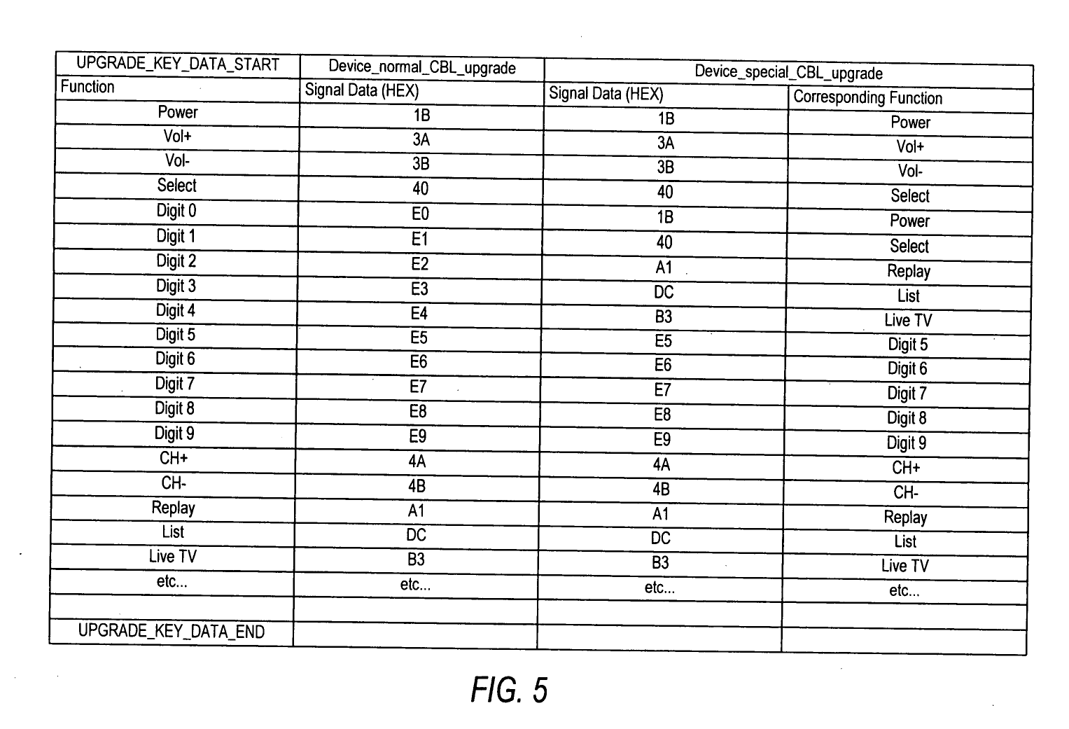

In accordance with the invention, the signal formatting data to enable the remote control unit to be used to clear or erase a memory component of an electronic device, such as a hard drive of a DVR, may be formed as this second group of signal formatting data which is written to the corresponding section of memory in Step 132. For example, FIG. 5 shows the correspondence between the keys of the universal remote control unit, listed by their designated function, a set of signal data for a “normal” CBL upgrade and signal data for the “special” CBL upgrade. The “special” CBL upgrade includes signal formatting data which provides the remote control unit with the ability to be programmed to enable a user to clear or erase the hard drive of a DVR by pressing a specific sequence of keys (discussed below with reference to their corresponding function as set forth in FIG. 5).

The method returns to Step 114 to monitor for new key presses. Thereafter the user inputs via the keypad the second group of signal formatting data information provided by the manufacturer of the remote control unit or the manufacturer of the electronic device. In Step 118 the method checks for the entry of digit keys and then the SELECT key. If the digit keys and SELECT key are pressed, as explained above in connection with the entry of the first set of signal formatting data information (YES in Step 118), the data is stored in the memory address location designated in Step 132 (Step 130) and the signal formatting data information is continually input by the user and stored in the corresponding section of the memory (Steps 114, 118 and 130) until all of the signal formatting data information for the second group has been entered.

After the 16 bit data of the second group of signal formatting data information is entered, the method returns to Step 114 wherein the user will preferably press the Arrow Down key, which is indicative of the user wanting to enter the third set of signal formatting data information for storage in memory. If the Arrow Down key is pressed (YES in Step 124), the flag is set in the memory for writing key data information to the designated section of the memory (Step 134). The method then returns to Step 114 wherein the user enters the key data information by pressing the digit keys provided by the manufacturer of the remote control unit or the manufacturer of the electronic device and then the SELECT key. After each two key presses, the user preferably presses the SELECT key (YES in Step 118) and the corresponding data is stored in the area of memory designated in Step 134.

After the user has entered all of the key presses corresponding to the third group of signal formatting data information, the user will press the Arrow Up key (YES in Step 126) which changes the current device mode and instructs the remote control unit to utilize the new upgraded code when generating signals to transmit commands to the particular device identified in Step 112. The remote control device then provides a visual indication to the user that the update process is complete by flashing LEDs of the remote control unit for a predetermined period of time (Step 136) to indicate that the update process is complete. The method then exits the upgrade programming mode (Step 138) and the device returns to normal operation (Step 106).

For each electronic device which does not respond to the control codes generated by the signal formatting data stored in the remote control unit, the user can repeat the above process to enter new signal formatting data to remotely control the specific electronic device.

In the event that after the new signal formatting data is entered by the user, certain key presses of the remote control unit do not properly control the corresponding electronic device, the user can re-enter the upgrade programming mode and re-enter the first, second and third groups of signal formatting data information, or any one of the first, second and third groups of signal formatting data information by selecting the specific group to be updated. That is, if the user determines that an error in digit key entry occurred while entering the first group of signal formatting data information, the user can re-enter that information (without having to enter the second and third groups of information) by pressing the Arrow Left key (Step 120) and entering the appropriate data in Step 114 to have the data stored in Step 130. If the user confirms that only the first group of signal formatting data needed to be corrected, the user could then exit the programming mode by pressing the Arrow Up key (Step 126).

By segmenting the signal formatting data information into three groups, in the event that an error occurs during input of the signal formatting data, the user can select the specific group of data which the user believes is incorrect, as opposed to inputting all three groups of the signal formatting data.

Referring now to FIG. 3B, a chart is shown which indicates the actions taken by the remote control unit with respect to its memory after the input of the device type, the first portion of the signal formatting data, the second portion of the signal formatting data and the third portion of the signal formatting data.

Referring now to FIG. 3C, a method of using the updated signal formatting data stored in the memory of the remote control unit to control an electronic device is shown.

Step 200 is indicative of the normal operation mode wherein the remote control unit continually monitors for a key press (Step 202). After a key press has been recognized (YES in Step 202), a determination is made as to whether the key pressed is a valid key for the device being controlled (Step 204). If the key pressed is not a valid key for the device being controlled NO in Step 204), the method returns to monitor for a next key press (Step 202).

Once a valid key for the device being controlled has been pressed (YES in Step 204), a determination is made as to whether the current code for the device being controlled is an update code (Step 206). If the current code for the device being controlled is not an update code (NO in Step 206), the remote control unit determines which previously stored signal formatting data has been indicated as controlling the particular device (Step 208) and the remote control unit locates the corresponding signal formatting data in the code library to generate the appropriate control signal (YES in Step 208). If a specific pre-stored signal formatting data has not been indicated as controlling the electronic device and cannot be identified by the remote control unit (NO in Step 208), the electronic device cannot be controlled and the method ends (Step 210).

If the signal formatting data which controls the electronic device is found in the code library of the memory (YES in Step 208), the processor generates a control signal in accordance with the signal formatting data and transmits the control signal via the transmitter (Step 212).

Returning to Step 206, if the current code for the device is an update code (YES in Step 206), the signal formatting data which is stored in the memory in association with the update code for the particular device is decoded (Step 214), and an appropriate control signal is generated and transmitted via the processor and transmitter to control the electronic device (Step 212).

It may occur during execution of the update programming mode that the user incorrectly enters information via the keypad. As previously indicated, to correct entered values before the SELECT key is depressed, the user can re-enter the two correct values and then press the SELECT key. This serves to overwrite or erase the previously incorrectly entered data with the newly entered data. However, to correct either the device type being updated or the first, second or third portions of the signal formatting data after an arrow key has been depressed, the user can re-enter the key presses and press the corresponding Arrow key to store the information at the appropriate location of memory for that electronic device. If the user determines that there were incorrect key presses after the entire update has been performed, the user can return to the programming mode and enter the code corresponding to the specific device signal formatting data which is to be corrected. Since the signal formatting data is divided into three portions, the user will identify which portion of the data was incorrectly entered (either the first portion corresponding to protocol information, the second portion corresponding to key data information, or the third portion corresponding to additional protocol information). The user will re-enter either the first portion, second portion or third portion of the signal formatting data and depress the corresponding arrow key such that the just input data will be stored at the appropriate location in the memory.

An advantage of the update programming method is that once the user has completed the process of updating the memory with additional signal formatting data, the signal formatting data is stored until the user changes the signal formatting data for that particular device. Therefore, if updated signal formatting data is stored in the remote control unit and the user is desirous of utilizing the remote control unit to control an electronic device which can be controlled by one of the pre-stored codes in the remote control unit, the user can switch between the newly added code and the pre-stored code as desired.

Another advantage is that the remote control unit can be directly updated by a user without the necessity of a technician being dispatched to the user or additional expensive components such as a receiver, serial or USB port, or slot for acceptance of additional memory.

Referring now to FIGS. 2A, 2B and 2C, there are various ways to perform channel memory programming in accordance with the invention. In one process shown in flow chart form in FIG. 2A, a determination is made at 16 whether the M1 button on the remote control unit is pressed, which would be indicative of a desire to perform channel memory programming, and if not, the program terminates at 18. If the M1 button is pressed, a determination is made at 20 whether the CBL button on the remote control unit is also pressed, indicative of a desire to program the cable device. If not, the program terminates at 18. If the CBL button is pressed, a determination is made at 22 whether the M1 and CBL buttons have been pressed for at least three seconds (although any predetermined period of time can be alternatively used). If not, the program terminates at 18. If the M1 and CBL buttons on the remote control unit have been pressed for three seconds, then the LED associated with or backlighting the CBL button stays on at 24 and the user proceeds to enter the first channel to be programmed using numerical entry keys on the universal remote control unit at 26. In the example shown in FIG. 2A, four numerical entry keys may be pressed. If the user does not enter the first channel to be programmed, then the program terminates at 18.

If the user wants to programs multiple channels, after the numbers for the first channel are entered, the user presses a “Channel Up” key (CH+) at 28 and enters a second channel to be programmed at 30. If the user does not enter the second channel to be programmed, then the program terminates at 18.

After the user enters the second channel, the user can then press the M1 key to confirm the memory programming, causing the LED associated with the CBL button to blink a predetermined number of times, e.g., three times, at 32. Thereafter, the process terminates at 18.

In an alternative channel memory programming process shown in FIG. 2B, a determination is made at 34 whether the M2 button on the remote control unit is pressed and if not, the program terminates at 36. If the M1 button is pressed, a determination is made at 38 whether the CBL button on the remote control unit is also pressed. If not, the program terminates at 36. If the M2 and CBL buttons are both determined to be pressed, a determination is made at 40 whether the M2 and CBL buttons have been pressed for at least three seconds, or any other predetermined amount of time. If not, the program terminates at 36. If the M2 and CBL buttons have been pressed for three seconds, then the LED associated with or backlighting the CBL button stays on at 42 and the user proceeds to enter the first channel to be programmed using numerical entry keys on the universal remote control unit at 44. If the user does not enter the first channel to be programmed, then the program terminates at 36.

If the user wants to programs multiple channels, after the numbers for the first channel are entered, the user presses a “Channel Up” key (CH+) at 46 and enters a second channel to be programmed at 48. If the user does not enter the second channel to be programmed, then the program terminates at 36.

After the user enters the second channel, the user can then press the M1 key to confirm the memory programming, causing the LED associated with the CBL button to blink a predetermined number of times, e.g., three times, at 50. Thereafter, the process terminates at 36.

In an alternative process shown in FIG. 2C, a determination is made at 52 whether the M3 button on the remote control unit is pressed and if not, the program terminates at 54. If the M3 button is pressed, a determination is made at 56 whether the CBL button on the remote control unit is also pressed. If not, the program terminates at 54. If the CBL button is pressed, a determination is made at 58 whether the M3 and CBL buttons have been pressed for a predetermined amount of time, e.g., three seconds. If not, the program terminates at 54. If the M3 and CBL buttons have been pressed for three seconds, then the LED associated with or backlighting the CBL button stays on at 60 and the user proceeds to enter the first channel to be programmed using numerical entry keys on the universal remote control unit at 62. If the user does not enter the first channel to be programmed, then the program terminates at 54.

If the user wants to program multiple channels, after the numbers for the first channel are entered at 62, the user presses a “Channel Up” key (CH+) at 64 and enters a second channel to be programmed at 66. If the user does not enter the second channel to be programmed, then the program terminates at 54. Otherwise, after the numbers for the second channel are entered at 66, the user presses a “Channel Up” key (CH+) at 68 and enters a third channel to be programmed at 70. This process continues with the user then pressing a “Channel Up” key (CH+) at 72 and entering a fourth channel to be programmed at 74, pressing a “Channel Up” key (CH+) at 76 and entering a fifth channel to be programmed at 78.

After the user enters the fifth channel, the user can then press the M1 key to confirm the memory programming, causing the LED associated with the CBL button to blink a predetermined number of times, e.g., three times, at 80. Thereafter, the process terminates at 54.

Once the cable code 10 has been upgraded in accordance with one of the processes shown in FIGS. 3A, 3B and 3C and channel memory programming has been performed in accordance with one of the processes shown in FIGS. 2A, 2B and 2C, the method can proceed to the implementation of a command to enable the erasing or clearing of the memory component of the DVR.

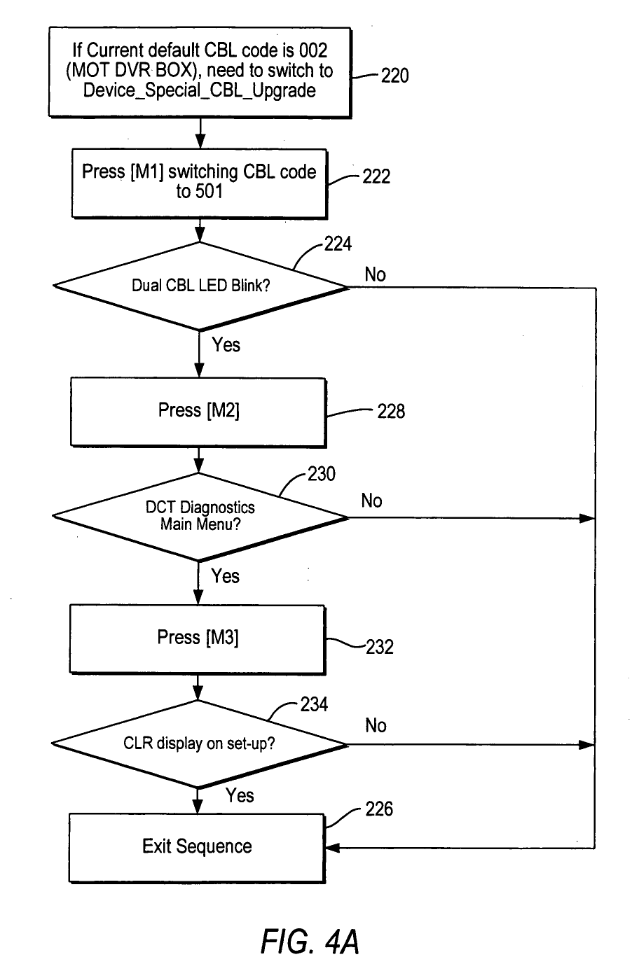

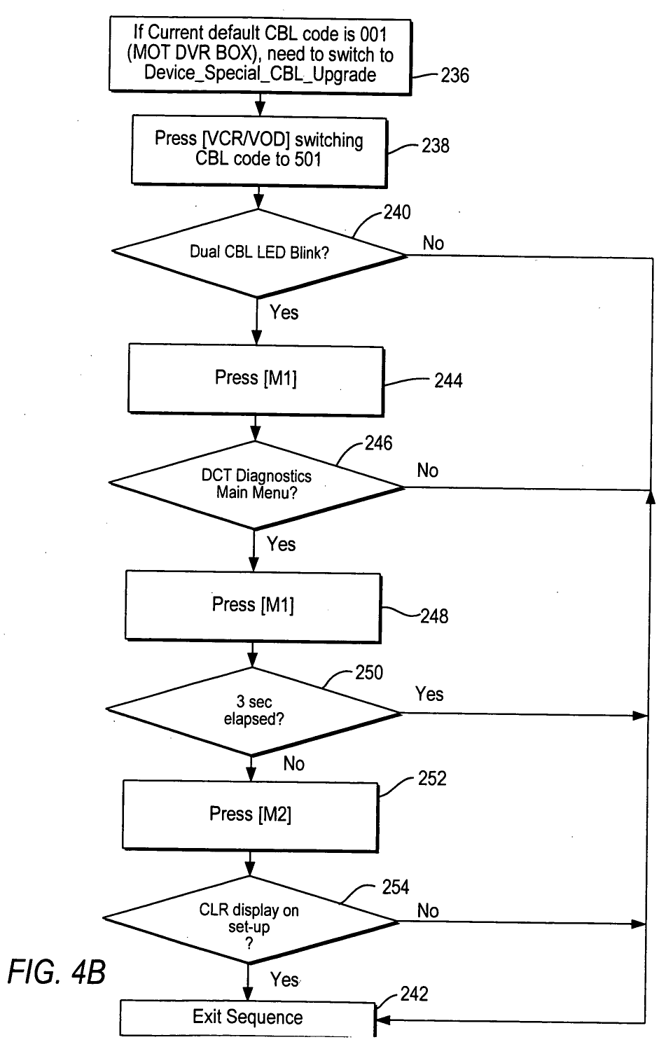

Referring then to FIG. 4A, the steps of a first process for implementing the erasing or clearing function of a memory component, usually a hard drive, of a DVR are shown. If the current default CBL code 10 is 002 (an assigned code for a Motorola DVR box), then the remote control unit needs to be switched to a special CBL upgrade code, namely code 501 (220). The default CBL code 002 performs substantially the same functions as the current remote with a Motorola DVR box, e.g., the M1, M2 and M3 keys will send out programmed news, music and sport channels.

To switch the CBL code, the user presses M1 on the remote control unit at 222 and determines at 224 whether the LED backlighting the CBL button on the remote control unit blinks a predetermined number of times, e.g., twice, indicating that the cable code has been changed to code 501. If not, the process terminates at 226. If the CBL LED blinks twice, the user then presses the M2 button on the remote control unit at 228 to view the Diagnostic Main Menu at 230. If the Diagnostic Main Menu is not viewed, the process terminates at 226. From the Diagnostic Main Menu, the user presses the M3 button at 232 to enter into the hard drive erasing or clearing sequence.

The designated sequence of key presses to cause the DVR to erase its hard drive has been selected to be a sequential depression of the following buttons on the remote control unit: “REPLY”, “LIST”, “LIST”, “LIST” and “LIVE TV” (or [2], [3], [3], [3], [4] as can be seen from FIG. 5). Once this sequence of buttons on the remote control unit is pressed, the DVR will erase its hard drive and once the erasure is completed, it will provide a CLR display, clear display on set-up, at 234. The process is then terminated.

It should be understood that the remote control unit may be programmed to require a different sequence of depression of keys or strokes of the keypad to erase the DVR hard drive. This is possible by changing the signal data being assigned to each key of the remote control unit. Thus, the table shown in FIG. 5 would be reconfigured to assign the signal data (Hex) for the “REPLY”, LIST” and LIVE TV” keys as shown, “A1”, DC” and “B3” respectively, to different keys, in order to provide for the desired sequence of key depressions to cause erasing of the hard drive of the DVR. The manner in which the signal formatting data is assigned to the keys of the remote control unit may therefore be freely selected by the programmer, so long as the sequence which enables the erasing of the hard drive is remembered and can be provided to the user.

The user can then press the M1 button, causing the CBL LED to blink, and resetting the cable code of the remote control unit to the default code 002.

If the remote control unit is set to control an electronic device other than the CBL, then the user would have to press the MODE button and then the CBL button to change to CBL, and once the process is complete, press the MODE button again and then, for example, the TV button.

The invention also allows a user to confirm that they are in the programming mode, i.e., the cable code is 501, by pressing the CBL and SELECT buttons and then the INFO button. The current code will appear, i.e., a code of 501 if the remote control unit is set in the programming mode to enable erasing of the hard drive of the DVR. Pressing M1 causes the code to be changed to code 501 which allows for the subsequent entry of the specific sequence above to enable erasing of the hard drive. Once the code is determined to be 501, the user can press the CBL and M2 buttons to enter into the programming mode and then [0] and [1], then M1 to cause the LED backlighting the CBL button to blink three times. This is for the POWER and SELECT signals. Pressing the CBL and M3 buttons brings the user into the programming mode wherein entry of the sequence set forth above causes the M1 LED to blink three times indicating entry of the sequence causing erasing of the hard drive.

Referring now to an alternative process in FIG. 4B, the steps of a second process for implementing the erasing or clearing function of a hard drive of a DVR are shown. If the current default CBL code 10 is 001 (an assigned code for a Motorola DVR box), then the remote control unit needs to be switched to a special CBL upgrade code, namely code 501 (236). The default CBL code 001 performs substantially the same functions as the current remote with a Motorola DVR box, e.g., the M1, M2 and M3 keys will send out programmed news, music and sport channels.

To switch the CBL code 10, the user first presses a VCR/VOD button on the remote control unit at 238 to switch the CBL code to 501 and determines at 240 whether the LED backlighting the CBL button on the remote control unit blinks a predetermined number of times, e.g., twice, indicating that the cable code has been changed to code 501. If not, the process terminates at 242. If the CBL LED blinks twice, the user then presses the M1 button on the remote control unit at 244 to view the Diagnostic Main Menu at 246. If the Diagnostic Main Menu is not viewed, the process terminates at 242. From the Diagnostic Main Menu, the user presses the M1 button again at 248. A determination is made as to whether a predetermined period of time, e.g., three seconds, has elapsed, at 250. If so, the program terminates at 242. If, from the Diagnostic Main Menu, the user presses the M2 button at 252 before three second have elapsed, the remote control unit enters into the hard drive erasing or clearing sequence.

The designated sequence of key presses to cause the DVR to erase its hard drive has been selected to be a sequential depression of the following buttons on the remote control unit: “REPLY”, “LIST”, “LIST”, “LIST” and “LIVE TV” (or [2], [3], [3], [3], [4] as can be seen from FIG. 5). Once this sequence of buttons on the remote control unit is pressed, the DVR will erase its hard drive and once the erasure is completed, it will provide a CLR display, clear display on set-up, at 254. The process is then terminated.

The user can then press the VCR/VOD button, causing the CBL LED to blink, and resetting the cable code of the remote control unit to the default code 001.

If the remote control unit is set to control an electronic device other than the CBL, then the user would have to press the MODE button and then the CBL button to change to CBL, and once the process is complete, press the MODE button again and then, for example, the TV button.

The invention also allows a user to confirm that there are in the programming mode, i.e., the cable code is 501, by pressing the CBL and SELECT buttons and then the INFO button. The current code will appear, i.e., a code of 501 if the remote control unit is set in the programming mode to enable erasing of the hard drive of the DVR. Pressing the VCR/VOD button causes the code to be changed to code 501 which allows for the subsequent entry of the specific sequence above to enable erasing of the hard drive. Once the code is determined to be 501, the user can press the CBL and M1 buttons to enter into the programming mode and then [0] and [1], then M1 to cause the LED backlighting the CBL button to blink three times. This is for the POWER and SELECT signals. Pressing the CBL and M2 buttons brings the user into the programming mode wherein entry of the sequence set forth above causes the M1 LED to blink three times indicating entry of the sequence causing erasing of the hard drive.

Thus, while various embodiments of the present invention have been illustrated and described, it will be appreciated by those skilled in the art that changes and modifications may be made thereunto without departing from the spirit and scope of the invention. For example, while it has been described that the mode pushbuttons will illuminate to indicate that the update programming mode has been entered, it is envisioned that other suitable indicators such as audio, visual or tactile indicators could also be utilized.

1. A method of clearing a memory component of an electronic device using a universal remote control unit which includes a keypad having keys, the method comprising:
initiating, by a user, an updating mode;
entering, by a user, a code associated with the device to be controlled by the remote control unit;
entering, by a user, a signal formatting data entry which includes signal formatting data, via the keys of the keypad, to be stored in a memory of the remote control unit;
associating the type of device to be controlled by the remote control unit with the signal formatting data entry; and
forming the signal formatting data to allow a sequence of depression of keys to cause the memory component of the device to be cleared when the device having the memory component is being controlled by the remote control unit.

2. The method of claim 1, wherein the signal formatting data is formed to require depression of a plurality of different keys in a particular sequence to cause the memory component of the device to be cleared.

3. The method of claim 1, further comprising imposing a time limit on the depression of the sequence of keys to cause the memory component of the device to be cleared.

4. The method of claim 1, wherein the step of initiating comprises the user entering, via the keys of the keypad, a code which initiates the updating mode.

5. The method of claim 1, wherein the step of entering, by a user, a code associated with the device to be controlled by the remote control unit, comprises entering the code via the keys of the keypad.

6. The method of claim 1, wherein when a type of device key associated with the device is subsequently depressed, subsequent commands sent by the remote control unit have a format specified by the signal formatting data.

7. The method of claim 1, wherein when a command key uniquely associated with the device is depressed, commands sent by the remote control unit have the format specified by the signal formatting data.

8. The method of claim 1, wherein the signal formatting data includes first, second and third portions stored at respective locations in the memory.

9. The method of claim 8, wherein one of the first, second and third portions includes special upgrade data relating to the ability to enable the memory component of the device to be cleared.

10. A universal remote control unit for remotely controlling a plurality of devices, one of the devices having a memory component which can be rewritten, comprising:
a memory having a plurality of locations for storing signal formatting entries at respective locations in the memory which are permanently written therein, and a location for storing a signal formatting entry which can be rewritten;
a keypad having a plurality of keys for entering, by a user, a first sequence of keypad strokes for actuating an upgrade mode, entering, by a user, a second sequence of keypad strokes indicative of new signal formatting data not previously stored in the memory, and entering, by a user, a third sequence of keypad strokes indicative of a desire to cause the memory component of the device to be cleared;
a transmitter;
a processor, which when an upgrade mode is actuated by the user entering the first sequence of keypad strokes, enabling the user to enter the second sequence of keypad strokes indicative of the new signal formatting data not previously stored in the memory, and storing the new signal formatting data in one of the plurality of memory locations for storing signal formatting data not previously stored in the memory,
whereby the new signal formatting data causes entry of the third sequence of keypad strokes to cause the memory component of the device to be cleared when the device having the memory component is being controlled by the remote control unit.

11. The universal remote control unit of claim 10, wherein the third sequence of keypad strokes includes depression of a plurality of different keys in a particular sequence.

12. The universal remote control unit of claim 10, wherein the new signal formatting data relating to entry of the third sequence of keypad strokes imposes a time limit on the keypad strokes.

13. The universal remote control unit of claim 10, wherein the keypad is utilized for entering, by a user, a fourth sequence of keypad strokes indicative of a device type associated with the new signal formatting data.

14. The universal remote control unit of claim 10, wherein the processor accesses the new signal formatting data from the memory to control the transmitter to transmit a control signal in conformance with the new signal formatting data in response to actuation of the keypad.

15. The universal remote control unit of claim 10, wherein the new signal formatting data includes first, second and third portions.

16. The universal remote control unit of claim 10, wherein one of the first, second and third portions includes special upgrade data relating to the ability to enable the memory component of the device to be cleared.

17. The universal remote control unit of claim 10, wherein the memory includes a plurality of locations for storing a plurality of signal formatting entries.

18. An article of manufacture comprising:
a computer usable medium having computer readable program code means embodied therein for updating a memory of a universal remote control unit which includes a keypad having keys, the computer readable program code means in said article of manufacture comprising:
a computer usable medium having computer readable program code means embodied therein for initiating, by a user, an updating mode;
a computer usable medium having computer readable program code means embodied therein for entering, by a user, a code associated with a device type to be controlled by the remote control unit;
a computer usable medium having computer readable program code means embodied therein for entering, by a user, a signal formatting data entry which includes signal formatting data, via the keys of the keypad, to be stored in the memory of the remote control unit;
a computer usable medium having computer readable program code means embodied therein for associating the device type to be controlled by the remote control unit with the signal formatting data entry; and
a computer usable medium having computer readable program code means embodied therein for forming the signal formatting data to allow a sequence of depression of keys to cause a memory component of a device being controlled by the remote control unit to be cleared when the device having the memory component is being controlled by the remote control unit.
